(19) United States
(12) Patent Application Publication
(10) Pub. No.: US 2021/0390918 A1
(43) Pub. Date: Dec. 16, 2021

(54) CONVERSION DEVICE FOR CONVERTING BLACK-AND-WHITE OR GRAYSCALE FRAMES FOR COLOR DISPLAY, AND ELECTRONIC DEVICE AND COLOR DISPLAY DEVICE USING THE SAME

(71) Applicant: Mars Semiconductor Corp., Hsinchu City (TW)

(72) Inventors: CHIEN-LIANG LIU, HSINCHU CITY (TW); Yi-Shing Chang, Hsinchu City (TW)

(21) Appl. No.: 16/903,025

(22) Filed: Jun. 16, 2020

(51) Int. Cl. G09G 3/36

(52) U.S. Cl. CPC G09G 3/3607; G09G 3/3688

(57) ABSTRACT

A conversion device for converting black-and-white or grayscale frames for a color display, and an electronic device and a color display device using the conversion device are disclosed. The conversion device includes a plurality of hardware circuits electrically connected to one another for receiving an input data provided by a control circuit. The input data includes a control signal, a string signal, a number signal or a symbol signal and the hardware circuits draw a color frame according to the input data to generate a color frame data for the color display; or alternatively, the input data includes a plurality of pixel signals of a black-and-white or grayscale frame, the hardware circuits convert the input data into a color frame data for the color display, and no input clock or reference clock for adjusting an output rate of the color frame data is received or generated by the conversion device.

### TECHNICAL FIELD

The present disclosure relates to a conversion device for converting black-and-white or grayscale frames for a color display and an electronic device and a color display device using the same, more particularly, to a conversion device capable of converting the black-and-white or grayscale frame from being displayed on an existing electronic device to a color display, and an electronic device and a color display device using the conversion device so as to display the black-and-white or grayscale frame thereon.

### BACKGROUND

Conventional electronics such as home appliances, machine tools, processing machines, watches and calculators may display information with black-and-white or grayscale pixel displays or black-and-white liquid crystal displays like seven-segment displays or black-and-white matrix liquid crystal displays. Therefore, the signals output by the conventional electronic device to the pixel display or the black-and-white liquid crystal display could be a plurality of black-and-white or grayscale pixels signals, a control signal, at least one string signal, at least one number signal, or at least one symbol signal of a frame. However, as color displays, such as color liquid crystal displays, are more common now, the production of pixel displays or black-and-white liquid crystal displays has decreased, and so the production cost of the pixel display or the black-and-white liquid crystal display is higher than that of the color display.

First, referring to FIG. 1, a conventional electronic device 1 includes a control circuit 11 and a black-and-white liquid crystal display 12, wherein the control circuit 11 is electrically connected to the black-and-white liquid crystal display 12 and outputs control signals, number signals, string signals or symbol signals so as to control the black-and-white liquid crystal display 12 to display a black-and-white frame corresponding to the signal data. For example, the electronic device 1 can be a landline telephone device and the control circuit 11 controls the black-and-white liquid crystal display 12 to display number digits according to buttons that were touched or pressed. Or, the electronic device 1 can be a processing machine, and the control circuit 11 outputs control signals, number signals, string signals, or symbol signals to control the black-and-white liquid crystal display 12 to display black-and-white frames corresponding to the output signals. In other implementations, the black-and-white liquid crystal display 12 of the electronic device 1 is replaced by a black-and-white or grayscale pixel display, and the control circuit 11 outputs multiple black-and-white or grayscale pixel signals of a frame to drive the pixel display to display the black-and-white or grayscale frame corresponding to the output signals.

Next, referring to FIG. 2, a conventional color liquid crystal display 2 includes a timing controller 21, a source driver 22, a gate driver 23 and a liquid crystal display panel 24, wherein the timing controller 21 is electrically connected to the source driver 22 and the gate driver 23, and the liquid crystal display panel 24 is electrically connected to the source driver 22 and the gate driver 23. The timing controller 21 receives color frame signals, wherein the resolution of the color frame signal typically corresponds to the resolution of the liquid crystal display panel 24. For instance, if the resolution of the liquid crystal display panel 24 is 1024*968*3 pixels, then the resolution of the color frame signals input to the timing controller 21 is also 1024*968*3 pixels. The timing controller 21 controls the gate driver 23 to sequentially drive multiple columns of pixel transistors in the liquid crystal display panel 24 and controls the source driver 22 to send the plurality of pixel signals to the pixel transistors in the corresponding columns.

From FIG. 1 and FIG. 2 and the description above, it is clear that due to the difference in data format, the color liquid crystal display cannot be used directly to replace the pixel display or the black-and-white liquid crystal display. Hence, when the pixel display or the black-and-white liquid crystal display of the conventional electronic device is broken or has a malfunction and needs to be replaced or changed, the technical problem arises and the cost for maintenance and repair could be higher.

### SUMMARY

To solve the aforementioned issues, an object of the present disclosure is to provide a conversion device for converting black-and-white or grayscale frames for a color display. The conversion device includes a plurality of hardware circuits electrically connected to one another, which are used to receive an input data provided by a control circuit and to generate or provide a color frame to the color display. The input data includes a control signal, a string signal, a number signal or a symbol signal and the hardware circuits draw a color frame according to the input data to generate the color frame data; or alternatively, the input data includes a plurality of pixel signals of a black-and-white or grayscale frame, the hardware circuits convert the input data into the color frame data, and no input clock or reference clock for adjusting an output rate of the color frame data is received or generated by the conversion device.

Another object of the present disclosure is to provide a color display device having a color display and the aforementioned conversion device, and yet another object of the present disclosure is to provide an electronic device having a control circuit and the aforementioned color display device.

Optionally, the control signal, the string signal, the number signal or the symbol signal is encoded by ANSI, ANSII, UTF-8 or BIG-5.

Optionally, the plurality of hardware circuits include a command interpretation unit, a font lookup unit, a graphic unit and a display control unit, wherein the font lookup unit, the graphic unit and the display control unit are controlled by the command interpretation unit. The font lookup unit looks up according to the control signal, the string signal, the number signal or the symbol signal. The graphic unit draws the color frame based on a lookup result of the font lookup unit. The display control unit generates the color frame data from the color frame drew by the graphic unit and generates all clocks and signals required to control the color display in displaying the color frame.

Optionally, the plurality of hardware circuits further include another graphic unit. The command interpretation unit controls the two graphic units according to different attributes to draw a plurality of dynamic image frames simultaneously, and the display control unit outputs two different color frame data to the color display at different time points.

Optionally, the plurality of hardware circuits are configured into a computing unit.

Optionally, the conversion device converts the gamut of the plurality of pixel signals of the black-and-white or grayscale frame from grayscale to color and generates the color frame data.

Optionally, the electronic device is a home appliance, a machine tool, a processing machine, a watch, or a calculator.

In short, the conversion device disclosed by the present disclosure allows a color display to replace a black-and-white liquid crystal display or a pixel display. Moreover, the conversion device can be integrated with the color display to form a color display device, or integrated with the color display and the control circuit to from an electronic device.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a block diagram of a conventional electronic device displaying a black-and-white frame using a black-and-white liquid crystal display.

FIG. 2 is a block diagram of a conventional color display.

FIG. 3 is a block diagram of an electronic device using a conversion device according to a first embodiment of the present disclosure.

FIG. 4 is a block diagram of a conversion device according to a second embodiment of the present disclosure.

FIG. 5 is a block diagram of a conversion device according to a third embodiment of the present disclosure.

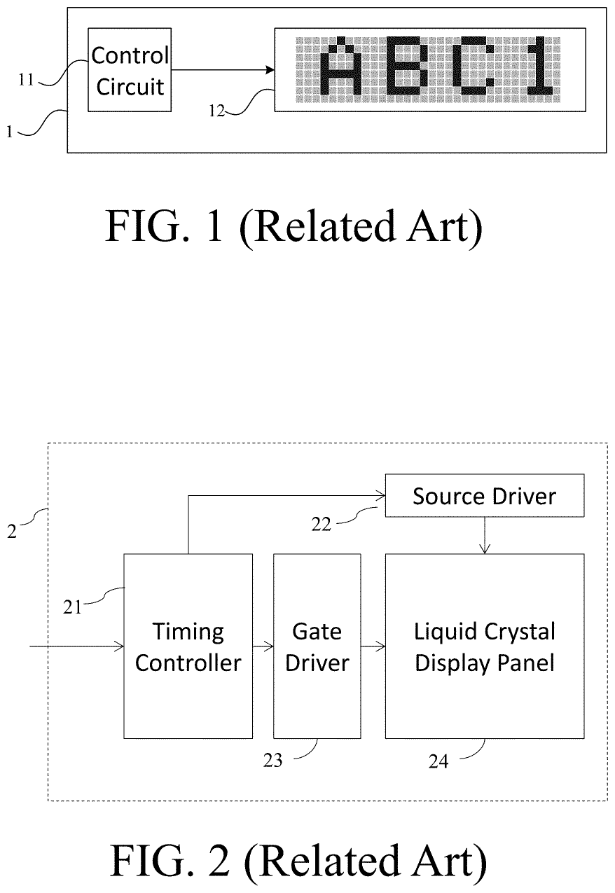

### DETAILED DESCRIPTION OF THE PREFERRED EMBODIMENTS

The present disclosure provides a conversion device that is capable of converting black-and-white or grayscale frames displayed on a conventional electronic device into displayable frames for a color display. As such, even if the pixel display or the black-and-white liquid crystal display of the conventional electronic device is broken or has a malfunction, a current color display, like a color liquid crystal display, can be used to replace the broken or damaged pixel display or black-and-white liquid crystal display by using the conversion device as an intermediary interface, and thereby effectively reducing the maintenance cost.

When an input data received by the conversion device is a control signal, at least one string signal, at least one number signal, or at least one symbol signal, the conversion device draws according to the control signal, at least one string signal, at least one number signal, or at least one symbol signal to generate a color frame data. When the input data received by the conversion device is a plurality of pixel signals of a black-and-white or grayscale frame, the conversion device converts the plurality of pixel signals of the black-and-white or grayscale frame into the color frame data (for example, a transformation of color domain (gamut) from grayscale to color is performed) and provides the color frame data directly to a color display so that the color display displays a color frame corresponding to the color frame data. The conversion device has no driver and so no input clock or reference clock is received or generated by the conversion device, and therefore when the content of the input data sent to the conversion device varies/changes, the color display changes the color frame displayed thereon by an interruptive manner.

Further, the frame refresh rate of a color display is generally at least 30 frames per second, but the output rate of the input data provided by the control circuit of the conventional electronic device does not correspond with the general frame refresh rate and is usually slower. Thus, a solution in the conventional technology is to generate a corresponding reference clock and increase the output rate of the color frame data to synchronize the output rate of the color frame data and the general frame refresh rate. The conversion device of the present disclosure itself does not receive input clock and does not generate reference clock to adjust the output rate of the color frame data. When the input data received by the conversion device changes/varies, before the color frame data of a new frame is fully received by the color display, the color display displays the color frame of the current color frame data, and until/after the color frame data of the new color frame is fully received by the color display, the new color frame is displayed. Therefore, the color display changes the color frame being displayed with a interruptive manner/behavior. Although users would feel/see the discontinuity between frames with this practice of displaying, the main purpose of the black-and-white liquid crystal display or the pixel display in the conventional electronic device is to display information, and so user experience on dynamic or lagged frame quality is not a concern and would not need to be taken into consideration. In addition, the aforementioned practice of displaying is achievable with hardware circuits that have lower cost and lower processing speed, which in turn lowers the manufacturing cost for the conversion device of the present disclosure, and so the cost of the conversion device and the color display as a whole is far less than the current black-and-white liquid crystal display and the pixel display.

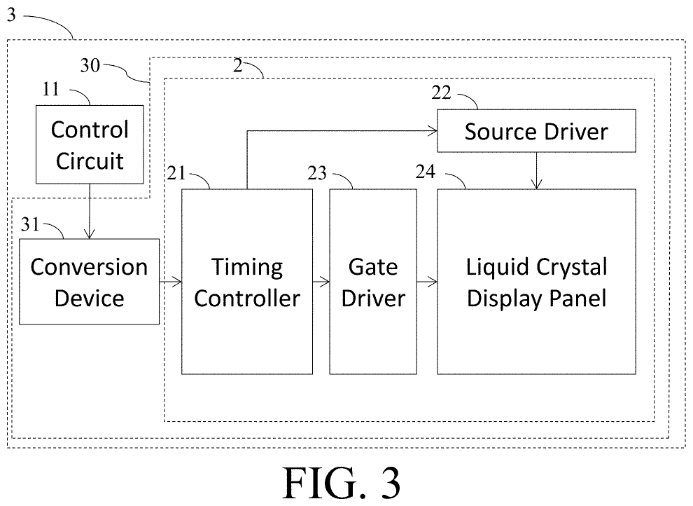

Now that the concept of the present disclosure has been stated, the details of each embodiment of the present disclosure will be described. Referring to FIG. 3, according to a first embodiment of the present disclosure, an electronic device 3 includes a control circuit 11 and a color display device 30, wherein the control circuit 11 is electrically connected to the color display device 30. The control circuit 11 is used to output control signals, number signals, string signals, or symbol signals for controlling a black-and-white liquid crystal display to display a corresponding black-and-white frame, or is used to output pixel signals of a black-and-white or grayscale frame for driving a pixel display to display the black-and-white or grayscale frame corresponding to the output signals.

The color display device 30 includes a conversion device 31 and a color display 2, wherein the color display 2 includes a timing controller 21, a source driver 22, a gate driver 23, and a liquid crystal display panel 24, and the conversion device 31 is electrically connected to the timing controller 21. The functions and connections of the timing controller 21, the source driver 22, the gate driver 23 and the liquid crystal display panel 24 are as aforementioned and are not described herein.

The conversion device 31 includes a plurality of hardware circuits electrically connected to one another, and the conversion device 31 is capable of converting a received input data, such as the control signal, the number signal, the string signal, the symbol signal, or the pixel signal of the black-and-white or grayscale frame output by the control circuit 31, into a color frame data which is then provided to a frame buffer of the timing controller 21 for temporarily storing and buffering. Hence, the color liquid crystal display 2 is able to display a color frame corresponding to the input data, namely, the control signal, the number signal, the string signal, the symbol signal, or the pixel signal of the black-and-white or grayscale frame output by the control circuit 11. Simply put, by integrating the conversion device 31 and the color liquid crystal display 2, the color display device 30 thus formed can be directly used in replacing the black-and-white liquid crystal display or the pixel display. Furthermore, the conversion device 31 and the color liquid crystal display 2 are integrated together in the first embodiment, but the present disclosure is not limited thereby, the conversion device 31 can also be an independent element acting as an intermediary interface between the color liquid crystal display 2 and the control circuit 11.

More specifically, when the input data output by the control circuit 11 to the conversion device 31 is a control signal, a number signal, a string signal, or a symbol signal, the conversion device 31 draws according to the control signal, the number signal, the string signal or the symbol signal to generate the color frame data. For example, the black-and-white liquid crystal display can be designed to display corresponding symbols according to the symbol signals, such as, displaying the number “8” when the symbol signal is a four-bit data depicting “1000”, and the conversion device 31 draws according to the symbol signal and generates a color frame data that can display the number “8” in a color frame. The number “8” of the color frame can be black, red, blue or green, and the present disclosure is not limited thereto. The aforementioned control signals, number signals, string signals, and symbol signals can be coded in any format like, but not limited to, ANSI, ANSII, UTF-8, or BIG-5.

And, when the input data output by the control circuit 11 to the conversion device 31 is a plurality of pixel signals of a black-and-white or grayscale frame, the conversion device converts the gamut of the pixel signals of the black-and-white or grayscale frame to obtain a corresponding color frame data (for example, a transformation of gamut from grayscale to color is performed). The plurality of hardware circuits of the conversion device 31 can be configured into a computing unit to achieve the gamut conversion of the pixel signals of the black-and-white or grayscale frame as mentioned above. Furthermore, the conversion device 31 itself does not receive input clock or generate reference clock to adjust the output rate of the color frame data to make the output rate of the color frame data correspond to the general frame refresh rate, and thus when the input data received by the conversion device 31 changes/varies in content, the color liquid crystal display 2 changes the displaying color frame through the interruptive manner.

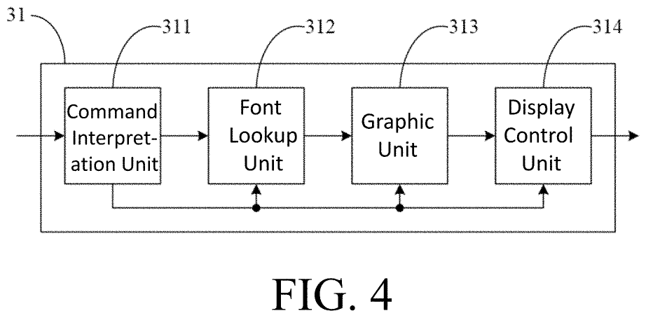

Referring to FIG. 4, according to a second embodiment of the present disclosure, the plurality of hardware circuits of the conversion device 31 includes a command interpretation unit 311, a font lookup unit 312, a graphic unit 313, and a display control unit 314, wherein the command interpretation unit 311 is electrically connected to the font lookup unit 312, the graphic unit 313, and the display control unit 314, the font lookup unit 312 is electrically connected to the graphic unit 313, and the graphic unit 313 is electrically connected to the display control unit 314. The command interpretation unit 311 interprets the commands given by the control circuit 11 and controls the font lookup unit 312, the graphic unit 313 and the display control unit 314 to perform corresponding tasks based on the different commands. The commands and tasks are, but not limited to, update font, update string, inverse text, etc.

The command interpretation unit 311 is capable of interpreting the command given by the control circuit, in other words, the command interpretation unit 311 determines the type of the input data and analyzes the command. For example, in a situation where the input data is determined to be a control signal, a number signal, a string signal, or a symbol signal, the command interpretation unit 311 first controls the font lookup unit 312 to lookup fonts and find a corresponding text pattern. Next, the graphic unit 313 draws the text pattern, which is a lookup result by the font lookup unit 312, in a programmable ratio and transparency with the resolution of the liquid crystal display panel on a proper location of a screen base map, to complete the drawing process and generate a corresponding frame. Then, the display control unit 314 converts the frame drew by the graphic unit 313 directly or a rotated frame thereof into a timing control signal, namely the color frame data, that is acceptable by the color liquid crystal display. The frame rotation allows a horizontal screen to be displayed in portrait or a vertical screen to be displayed in landscape, which increases the selectivity of color liquid crystal displays. Hence, the conversion device 31 draws the color frame data corresponding to the input data and further generates all of the clocks and signals needed/required to control the liquid crystal display panel in displaying the color frame.

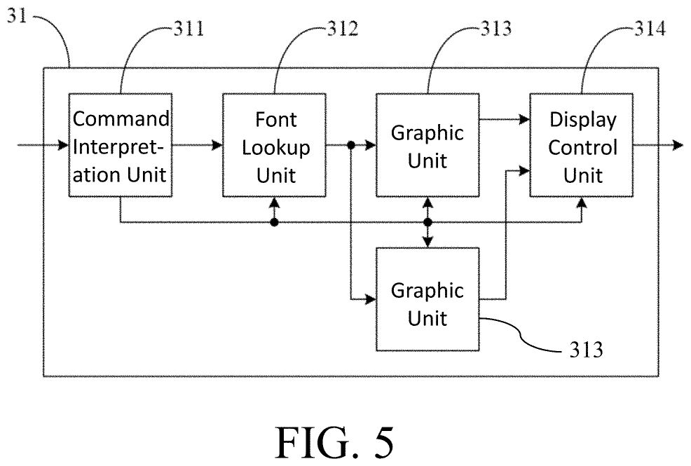

Referring to FIG. 5, according to a third embodiment of the present disclosure, the conversion device 31 realized the function of drawing dynamic frames from the input data by having more than two graphic units 313. The dynamic frames refer to, but not limited to, flashing text, news ticker, etc. The command interpretation unit 311 controls the graphic units 313 based on different attributes to draw a plurality of dynamic image frames at the same time or simultaneously, and finally, the display control unit 314 outputs two different color frame data at different time points so as to achieve the purpose of generating dynamic image signals for the color liquid crystal display according to timing of a time axis.

In view of above, the present disclosure provides a conversion device that is capable of converting black-and-white or grayscale frames that were displayed on a convention electronic device to be displayable on a color display. Therefore, when the pixel display or the black-and-white liquid crystal display of the convention electronic device is broken or has a malfunction, the conversion device can be used as an intermediary interface to allow the current color display, like a color liquid crystal display, to replace the broken or damaged pixel display or black-and-white liquid crystal display, and thereby reducing the maintenance cost. In addition, the conversion device can be integrated with the current color display to form a color display device and directly replace the pixel display or black-and-white liquid crystal display of the convention electronic device. Moreover, by integrating the control circuit of the conventional electronic device, the conversion device of the present disclosure, and the current color display, a new electronic thus formed has a reduced manufacturing cost.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

1. A conversion device for converting black-and-white or grayscale frames for a color display, the conversion device comprising:
a plurality of hardware circuits electrically connected to one another for receiving an input data provided by a control circuit;
wherein the input data comprises a control signal, a string signal, a number signal or a symbol signal, and the hardware circuits draw a color frame according to the input data to generate a color frame data for the color display; or alternatively, the input data comprises a plurality of pixel signals of a black-and-white or grayscale frame, the hardware circuits convert the input data into a color frame data to be provided to the color display, and no input clock or reference clock for adjusting an output rate of the color frame data is received or generated by the conversion device.

2. The conversion device of claim 1, wherein when the input data comprises the control signal, the string signal, the number signal or the symbol signal, the control signal, the string signal, the number signal or the symbol signal is encoded by ANSI, ANSII, UTF-8 or BIG-5.

3. The conversion device of claim 1, wherein when the input data comprises the control signal, the string signal, the number signal or the symbol signal, the plurality of hardware circuits comprise:
a command interpretation unit;
a font lookup unit controlled by the command interpretation unit;
a graphic unit controlled by the command interpretation unit; and
a display control unit controlled by the command interpretation unit;
wherein the font lookup unit looks up according to the control signal, the string signal, the number signal or the symbol signal, the graphic unit draws the color frame based on a lookup result of the font lookup unit, and the display control unit generates the color frame data from the color frame drew by the graphic unit and generates all clocks and signals required to control the color display in displaying the color frame.

4. The conversion device of claim 3, wherein the plurality of hardware circuits further comprise another graphic unit, the command interpretation unit controls the two graphic units according to different attributes to draw a plurality of dynamic image frames simultaneously, and the display control unit outputs two different color frame data to the color display at different time points.

5. The conversion device of claim 1, wherein when the input data comprises the plurality of pixel signals of the black-and-white or grayscale frame, the plurality of hardware circuits are configured into a computing unit.

6. The conversion device of claim 1, wherein the conversion device converts the gamut of the plurality of pixel signals of the black-and-white or grayscale frame from grayscale to color and generates the color frame data.

7. A color display device comprising:
a color display; and
a conversion device electrically connected to the color display for converting black-and-white or grayscale frames for the color display, the conversion device comprising a plurality of hardware circuits electrically connected to one another for receiving an input data from a control circuit, wherein the input data comprises a control signal, a string signal, a number signal or a symbol signal, and the plurality of hardware circuits draw a color frame according to the input data to generate a color frame data for the color display; or alternatively, the input data comprises a plurality of pixel signals of a black-and-white or grayscale frame, the plurality of hardware circuits convert the input data into a color frame data to be provided to the color display and no input clock or reference clock for adjusting an output rate of the color frame data is received or generated by the conversion device.

8. The color display device of claim 7, wherein when the input data comprises the control signal, the string signal, the number signal or the symbol signal, the control signal, the string signal, the number signal or the symbol signal is encoded by ANSI, ANSII, UTF-8 or BIG-5.

9. The color display device of claim 7, wherein when the input data comprises the control signal, the string signal, the number signal or the symbol signal, the plurality of hardware circuits comprise:
a command interpretation unit;
a font lookup unit controlled by the command interpretation unit;
a graphic unit controlled by the command interpretation unit; and
a display control unit controlled by the command interpretation unit;
wherein the font lookup unit looks up according to the control signal, the string signal, the number signal or the symbol signal, the graphic unit draws the color frame based on a lookup result of the font lookup unit, and the display control unit generates the color frame data from the color frame drew by the graphic unit and generates all clocks and signals required to control the color display in displaying the color frame.

10. The color display device of claim 9, wherein the plurality of hardware circuits further comprise another graphic unit, the command interpretation unit controls the two graphic units according to different attributes to draw a plurality of dynamic image frames simultaneously, and the display control unit outputs two different color frame data to the color display at different time points.

11. The color display device of claim 7, wherein when the input data comprises the plurality of pixel signals of the black-and-white or grayscale frame, the plurality of hardware circuits are configured into a computing unit.

12. The color display device of claim 7, wherein the conversion device converts the gamut of the plurality of pixel signals of the black-and-white or grayscale frame from grayscale to color and generates the color frame data.

13. An electronic device comprising:
a control circuit;
a color display; and
a conversion device electrically connected to the color display and the control circuit for converting black-and-white or grayscale frames for the color display, the conversion device comprising a plurality of hardware circuits electrically connected to one another for receiving an input data from the control circuit, wherein the input data comprises a control signal, a string signal, a number signal or a symbol signal, and the plurality of hardware circuits draw a color frame according to the input data to generate a color frame data for the color display; or
alternatively, the input data comprises a plurality of pixel signals of a black-and-white or grayscale frame, the plurality of hardware circuits convert the input data into a color frame data to be provided to the color display and no input clock or reference clock for adjusting an output rate of the color frame data is received or generated by the conversion device.

14. The electronic device of claim 13, wherein when the input data comprises the control signal, the string signal, the number signal or the symbol signal, the control signal, the string signal, the number signal or the symbol signal is encoded by ANSI, ANSII, UTF-8 or BIG-5.

15. The electronic device of claim 13, wherein when the input data comprises the control signal, the string signal, the number signal or the symbol signal, the plurality of hardware circuits comprise:
a command interpretation unit;
a font lookup unit controlled by the command interpretation unit;
a graphic unit controlled by the command interpretation unit; and
a display control unit controlled by the command interpretation unit;
wherein the font lookup unit looks up according to the control signal, the string signal, the number signal or the symbol signal, the graphic unit draws the color frame based on a lookup result of the font lookup unit, and the display control unit generates the color frame data from the color frame drew by the graphic unit and generates all clocks and signals required to control the color display in displaying the color frame.

16. The electronic device of claim 15, wherein the plurality of hardware circuits further comprise another graphic unit, the command interpretation unit controls the two graphic units according to different attributes to draw a plurality of dynamic image frames simultaneously, and the display control unit outputs two different color frame data to the color display at different time points.

17. The electronic device of claim 13, wherein when the input data comprises the plurality of pixel signals of the black-and-white or grayscale frame, the plurality of hardware circuits are configured into a computing unit.

18. The electronic device of claim 13, wherein the conversion device converts the gamut of the plurality of pixel signals of the black-and-white or grayscale frame from grayscale to color and generates the color frame data.

19. The electronic device of claim 13, wherein the electronic device is a home appliance, a machine tool, a processing machine, a watch, or a calculator.
